(19) United States
(12) Patent Application Publication
(10) Pub. No.: US 2007/0031008 A1
(43) Pub. Date: Feb. 8, 2007

(54) System and method for range measurement of a preceding vehicle

(75) Inventor: Shunji Miyahara, Yokohama-shi (JP)

Correspondence Address: VISTEON, C/O BRINKS HOFER GILSON & LIONE, PO BOX 10395, CHICAGO, IL, 60610, US

(73) Assignee: Visteon Global Technologies, Inc.

(21) Appl. No.: 11/195,427

(22) Filed: Aug. 2, 2005

(51) Int. Cl. G06K 9/00

(52) U.S. Cl. 382/106; 382/104

(57) ABSTRACT

A system for determining range and lateral position of a vehicle is provided. The system includes a camera and a processor. The camera is configured to view a region of interest including the vehicle and generate an electrical image of the region. The processor is in electrical communication with the camera to receive the electrical image. The processor analyzes the image by identifying objects and determining a relationship corresponding to the expected pixel values at various locations on the road. The processor calculates a value indicative of the validity that an object is a vehicle by comparing the pixel values of the object with the expected pixel values based on the relationship. A score is determined based on the comparison indicating the likelihood that certain characteristics of the electrical image actually correspond to the vehicle.

### BACKGROUND

1. Field of the Invention

The present invention generally relates to a system and method for range and lateral position measurement of a preceding vehicle on the road.

2. Description of Related Art

Radar and stereo camera systems for adaptive cruise control (ACC), have been already introduced into the market. Recently, radar has been applied for pre-crash safety systems and collision avoidance. Typically, the range and lateral position measurement of a preceding vehicle is accomplished utilizing radar and/or stereo camera systems. Radar systems can provide a very accurate range. However, millimeter wave type radar systems such as 77 Ghz systems are typically quite expensive. Laser radar is low cost, but requires mechanical scanning. Further, radar, is generally, not well suited to identify the object and give an accurate lateral position.

Stereo camera systems can determine the range and identity of an object. However, these systems are typically difficult to maintain due to the accurate alignment required between the two cameras and are expensive requiring two image processors, twice as many image processing as a single camera system.

Further both camera and radar systems can be easily confused by multiple objects in an image. For example, multiple vehicles in adjacent lanes and roadside objects can be easily interpreted as a preceding vehicle in the same lane as the vehicle carrying the system. In addition, brightness variation in the background of the image, like the shadows of vehicles and roadside objects, can also increase the difficulty of identifying the vehicle.

In view of the above, it can be seen that conventional ACC systems may have difficulty identifying vehicles due to a complex background environment. Further, it is apparent that there exists a need for an improved system and method for identifying and measuring the range and lateral position of the preceding vehicle.

### SUMMARY

In satisfying the above need, as well as, overcoming the enumerated drawbacks and other limitations of the related art, the present invention provides a system for determining range and lateral position of a vehicle. The primary components of the system include a camera and a processor. The camera is configured to view a region of interest containing a preceding vehicle and to generate an electrical image of the region. The processor is in electrical communication with the camera to receive the electrical image.

The electrical image includes many characteristics that make preceding vehicles difficult to identify. Therefore, the processor is configured to analyze a portion of the electrical image corresponding to the road and calculate an relationship to describe the change in pixel value of the road at various locations within the image. The processor is also configured to compare the pixel values at a location in the image where a vehicle may be present to the expected pixel value of the road, where the expected pixel value of the road is calculated based on the relationship.

To identify objects in the electrical image, the processor investigates a series of windows within the image, each window corresponding to a fixed physical size at a different target range. The series of windows are called the range-windows. Accordingly, each window's size in the image is inversely proportional to the range of the window. The processor evaluates characteristics of the electrical image within each window to identify the vehicle. For example, the size of the vehicle is compared to the size of each window to create a size ratio. The characteristics of the electrical image that are evaluated by the processor include the width and height of edge segments in the image, as well as, the height, width, and location of objects constructed from multiple edge segments. To analyze the objects, the width of the object is determined and a vehicle model is selected for the object from several models corresponding to a vehicle type, such as a motorcycle, sedan, bus, etc. The model provides the object a score on the basis of the characteristics. The scoring of the object characteristics is performed according to the vehicle model selected and the pixel value deviation from the expected road pixel value based on the calculated relationship. The score indicates the likelihood that the object is a target vehicle on the road. The object with the highest score becomes a target and the range of the window corresponding to the object will be the estimated range of the preceding vehicle. The analysis described above is referred to as range-window analysis.

In order to complement the range-window analysis, another analysis is also performed. The processor is configured to analyze a portion of the electrical image corresponding to the road surface for each range-window and calculate a relationship to describe the change in pixel value along the road surface at various locations within the image. The processor is also configured to compare the pixel values at a location in the image where a vehicle may be present to the expected pixel value of the road surface, where the expected pixel value of the road surface is calculated based on the relationship. The analysis described above is referred to as road surface analysis.

The combination of the road surface analysis and the range-window analysis provides a system with improved object recognition capability.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 is a side view of a system for range and lateral position measurement of a preceding vehicle, embodying the principles of the present invention;

FIG. 2 is a view of an electronic image from the perspective of the camera in FIG. 1;

FIG. 3 is a side view of the system illustrating the calculation of the upper and lower edge of the windows in accordance with the present invention;

FIG. 4 is a top view of the system illustrating the calculation of the left and right edge of the windows, in accordance with the present invention;

FIG. 5A is a view of the electronic image, with only the image information in the first window extracted;

FIG. 5B is a view of the electronic image, with only the image information in the second window extracted;

FIG. 5C is a view of the electronic image, with only the image information in the third window extracted;

FIG. 6 is a flowchart illustrating the algorithm executed by the system to determine the range of the preceding vehicle;

FIG. 7 is a view of an electronic image generated by the camera prior to processing;

FIG. 8 is a view of the electronic image after a vertical edge enhancement algorithm has been applied to the electronic image;

FIG. 9 is a view of the electronic image including segments that are extracted from the edge enhanced image; and

FIG. 10 is a view of the electronic image including objects constructed from the segments illustrated in FIG. 8.

FIG. 11 a view of the electronic image including a preceding vehicle illustrating the regions used to calculate the road brightness equation.

FIG. 12 is a graph showing the calculation of the road brightness equation and the comparison of the object pixel values.

FIG. 13 is a view of the electronic image illustrating a ghost object formed by vehicles in adjacent lanes.

FIG. 14 is a view of the electronic image illustrating three regions to be used in comparing the object pixel values to the expected road brightness equation.

FIG. 15 is a graph illustrating the calculation of the road brightness gradient in comparison of two regions to the road brightness equation.

### DETAILED DESCRIPTION

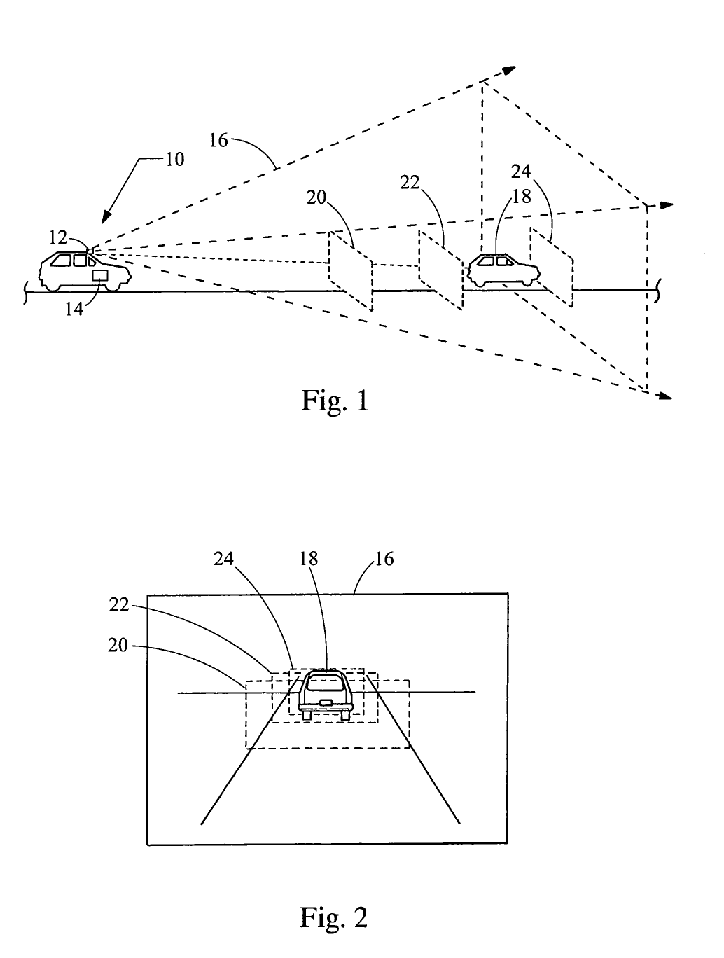

Referring now to FIG. 1 a system embodying the principles of the present invention is illustrated therein and designated at 10. As its primary components, the system 10 includes a single camera 12 and a processor 14. The camera 12 is located in the rearview mirror to collect an optical image of a region of interest 16 including a vehicle 18. The optical image received by the camera 12, is converted to an electrical image that is provided to the processor 14.

The electrical image includes many characteristics that make preceding vehicles difficult to identify. Therefore, the processor 14 is configured to analyze a portion of the electrical image corresponding to the road and calculate an equation to describe the change in pixel value of the road along the longitudinal direction within the image. For example, the equation may be calculated using a regression algorithm, such as a quadratic regression. The processor 14 is also configured to compare the pixel values at a location in the image where a vehicle may be present to the expected pixel value of the road, where the expected pixel value of the road is calculated based on the equation. The value is used to calculate an overall score indicating the likelihood a vehicle is present at the identified location.

To filter out unwanted distractions in the electronic image and aid in determining the range of the vehicle 18, the processor 14 calculates the position of multiple windows 20, 22, 24 within the region of interest 16. The windows 20, 22, 24 are located at varying target ranges from the camera 12. The size of the windows 20, 22, 24 are a predetermined physical size (about 4x2m as shown) and may correspond to the size of a typical lane width and height of a vehicle. To provide increased resolution the windows 20, 22, 24 are spaced closer together and the number of windows is increased. Although the system 10, as shown, is configured to track a vehicle 18 preceding the system 10, it is fully contemplated that the camera 12 could be directed to the side or rear to track a vehicle 18 that may be approaching from other directions.

Now referring to FIG. 2, an electronic image of the region of interest 16 as viewed by the camera 12 is provided. The windows 20, 22, 24 are projected into their corresponding size and location according to the perspective of the camera 12. The vehicle 18 is located between windows 22 and 24, accordingly, the size of the vehicle 18 corresponds much more closely to the height and width of windows 22 and 24 than window 20. As can be seen from FIG. 1, although the size and width of the windows are physically constant at each target range, the window sizes appear to vary from the perspective of the camera 12. Similarly, the height and width of the preceding vehicle 18 will appear to vary at each target range. The perspective of the camera 12 will affect the apparent size and location of the preceding vehicle 18 within the electrical image based on the elevation angle and the azimuth angle of the camera 12. The processor 14 can use the location and size of each of the windows 20, 22, 24 to evaluate characteristics of the electrical image and determine a score indicating the probability the vehicle 18 is at the target range associated with a particular window.

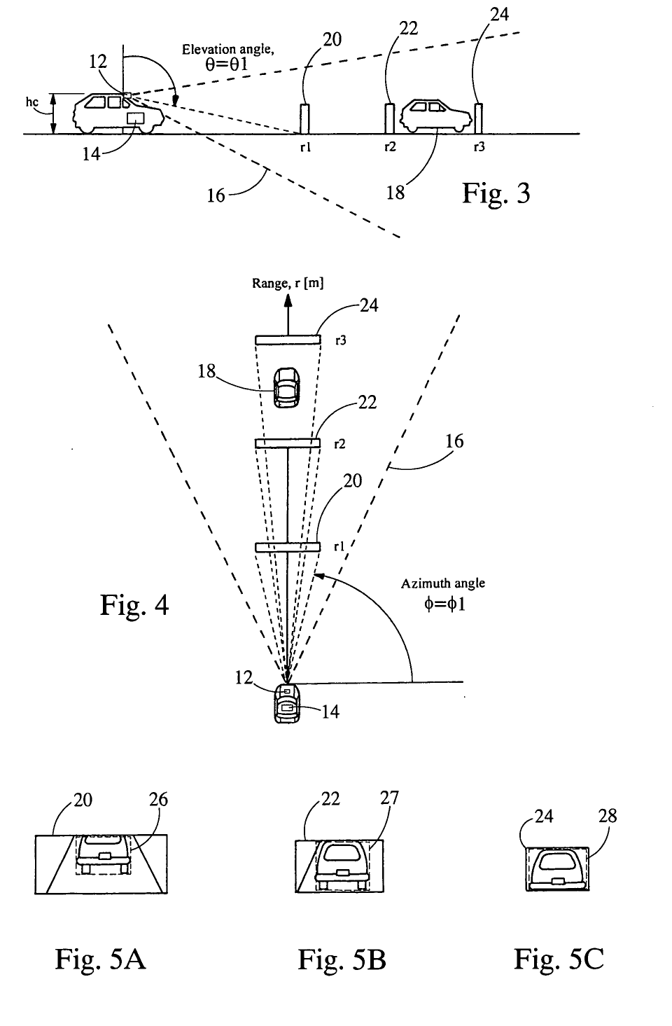

Now referring to FIG. 3, a side view of the system 10 is provided illustrating the use of the elevation angle in calculating the height and position of the window 20 within the electrical image. The elevation angle is the angle between the optical axis of the camera 12 and the surface of the road. The lower edge of window 20 is calculated based on Equation (1).
Θ₁=arctan(−r1/hc) (1)
Where hc is the height of the camera 12 from the road surface, r1 is the horizontal range of window 20 from the camera 12, and the module of arctan is [0, π].

Similarly, the upper edge of the first window is calculated based on Equation (2).
Θ₁ₕ=arctan(r1/(hw−hc) (2)
Where hw is the height of the window, hc is the height of the camera 12 from the road surface and r1 is the range of window 20 from the camera 12. The difference, ΔΘ₁ =Θ₁ −Θ₁ₕ, corresponds to the height of the window in the electronic image.

Now referring to FIG. 4, the horizontal position of the window in the electronic image corresponds to the azimuth angle. The azimuth angle is the angle across the width of the preceding vehicle from the perspective of the camera 12. The right edge of the range window 20 is calculated according to Equation (3).
φ₁=arctan(−width_{—}w/(2*r1))+(π/2) (3)

Similarly, the left edge of the range window 20 is calculated according to Equation (4).
φ₁ₕ=arctan(width_{—}w/(2*r1))+(π/2) (4)
Where window w is the distance from the center of the window 20 to the horizontal edges, r1 is the horizontal range of the window 20 from the camera 12, and the module of arctan is [−π/2,π/2].

The window positions for the additional windows 22, 24 are calculated according to Equations (1)-(4), substituting their respective target ranges for r1.

Now referring to FIG. 5A, the electronic image is shown relative to window 20. Notice the width of the object 26 is about 30% of the width of the window 20. If the window width is set at a width of 4m, about twice the expected width of the vehicle 18, the estimated width of the object 26 at a distance of r1 would equal 4×0.3=1.2 m. Therefore, the likelihood that the object 26 is the vehicle 18 at range r1 is low. In addition, the processor 14 evaluates vertical offset and object height criteria. For example, the distance of the object 26 from the bottom of the processing window 20 is used in determining likelihood that the object 26 is at the target range. Assuming a flat road, if the object 26 were at the range r1, the lowest position of the object 26 would appear at the bottom of the window 20 corresponding to being in contact with the road at the target range. However, the object 26 in FIG. 5A, appears to float above the road, thereby decreasing the likelihood it is located at the target range. Further, the extracted object 26 should cover a height of 0.5 m or 1.2 m. The processor 14 will detect an object including the height of 0.5m if the object is a sedan or 1.2 m if the object is a bus or large truck. The closer the height of the object 26 is to the expected height the more probable the object 26 is the vehicle 18 and the more probable it is located at the target range r1. The vertical offset, described above, may also affect the height of the object 26, as the top of the object, in FIG. 5A, is chopped off by the edge of the window 20. Therefore, the object 26 appears shorter than expected, again lowering the likelihood the object is the vehicle 18 at the range r1.

Now referring to FIG. 5B, the electronic image is shown relative to window 22. The width of the object 27 is about 45% of the window 22. Therefore, the estimated width of the object 27 at range r2 is equal to 4×0.45−1.8 m much closer to the expected size of the vehicle 18. In this image, the object 27 is only slightly offset from the bottom of the window 22, and the entire height of the object 27 is still included in the window 22.

Now referring to FIG. 5C, the electronic image is shown relative to window 24. The width of the object 28 is about 80% of the width of the window 24. Accordingly, the estimated width of the object 28 at range r3 is equal to 4×0.08=3.2 m. Therefore, the object width is significantly larger than the expected width of vehicle 18, usually about 1.75 m. Based on the object width, the processor 14 can make a determination that object 27 most probably corresponds to vehicle 18 and r2 is the most probable range. The range accuracy of the system 10 can be increased by using a finer pitch of target range for each window. Using a finer pitch between windows is especially useful as the vehicle 18 is closer to the camera 12, due to the increased risk of collision. Alternatively, the ratio between the estimated width and expected width is used to determine the most probable range.

In order to enhance the range-window analysis, a road surface analysis is added. The electrical image includes many characteristics that make preceding vehicles difficult to identify. Therefore, the processor 14 is configured to analyze a portion of the electrical image corresponding to the road surface and calculate an equation to describe the change in pixel value of the road along the longitudinal direction within the image. For example, the equation may be calculated using a regression algorithm, such as a quadratic regression. The processor 14 is also configured to compare the pixel values at a location in the image where a vehicle may be present to the expected pixel value of the road, where the expected pixel value of the road is calculated based on the equation. If the similarity between the pixel and expected values is high, the probability that an object exists at the location is low. Accordingly, the resulting score is low. If the similarity is low, the score is high. The results of the comparison are combined with the results of the range-window algorithm to generate a score that indicates the likelihood a vehicle is present at the identified location.

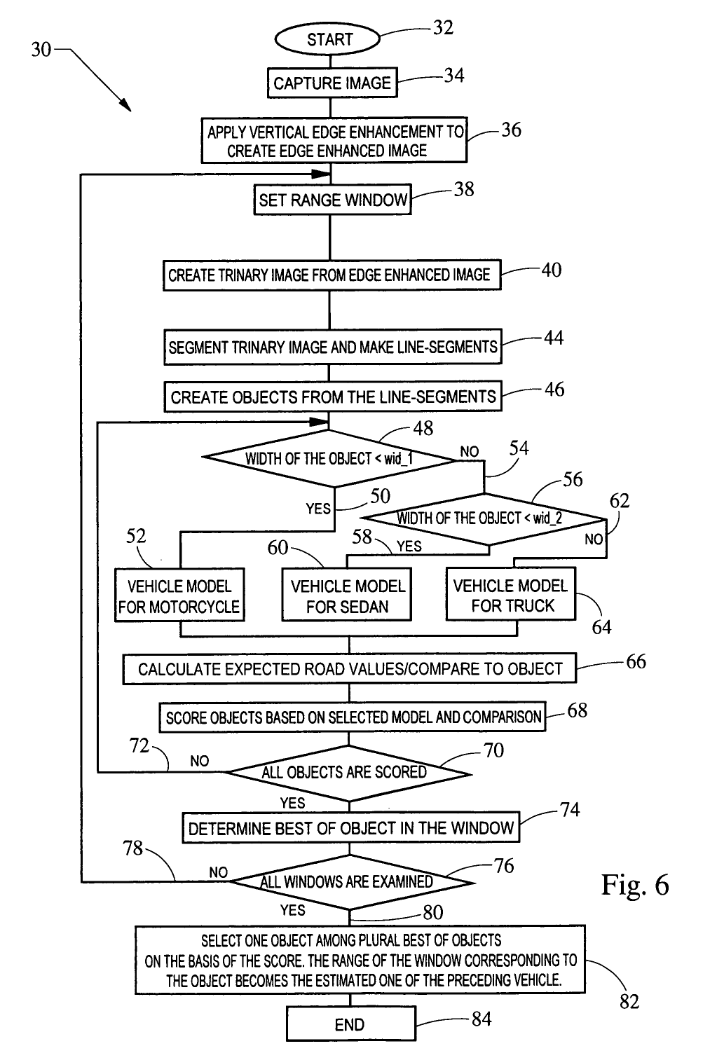

Now referring to FIG. 6, a method for processing an image according to the present invention is provided at reference numeral 30. Block 32 denotes the start of the method. In block 34, an image is captured by the camera 12 and transferred to the processor 14. The processor 14 applies vertical edge enhancement to create an edge enhanced image as denoted by block 36. In block 38, the processor 14 sets a range window to limit the region analyzed for that specific range, thereby eliminating potentially confusing edge information. A trinary image, in which the negative edge, positive edge and the others are assigned “−1”, “+1”, and “0”, is created within the range window from the edge enhanced image as denoted by block 40. In block 44, the trinary image is segmented to sort pixels of the same value and a similar location into groups called line-segments. Two segments with different polarity are grouped together to form objects that correspond to a potential vehicle, as denoted in block 46.

In block 48, the width of an object is compared to a width threshold to select the model. If the width of the object is less than the width threshold, the algorithm follows line 50 to block 52 where a vehicle model corresponding to a motor cycle is selected. If the width of the object is not less than the first width threshold, the algorithm follows line 54 to block 56. In block 56, the width of the object is compared to a second width threshold. If the width of the object is less than the second width threshold, the algorithm follows line 58 and a vehicle model corresponding to a Sedan is selected, as denoted in block 60. However, if the width of the object is greater than the second width threshold, the algorithm follows line 62 to block 64 where a model corresponding to a truck is selected, as denoted in block 64.

In block 66, the processor 14 calculates an equation corresponding to the expected change of the road pixel values across the image due to environmental conditions. The equation is used in the road surface analysis as previously discussed. Accordingly, the processor 14 then compares the pixel values in the object region to the expected pixel values of the road based on the equation. The processor then scores the objects based on the score of the selected model and the pixel value comparison, as denoted by block 68. In block 70, the processor 14 determines if all the objects for that range window have been scored. If all the objects have not been scored, the algorithm follows line 72 and the width of the next object is analyzed to select a vehicle model starting at block 48. If all the objects have been scored, the best object in the window (object-in-window) is determined on the basis of the score, 74. Then the processor determines if all the windows have been completed, as denoted by block 76. If all the windows have not been completed, the algorithm follows line 78 and the window is changed. After the window is changed, the algorithm follows line 78 and the next range window is set as denoted by block 38. If all the windows have been completed, the best object is selected from the best objects-in-window on the basis of the score and the range of the window corresponding to the object becomes the estimated range of the preceding vehicle, 82, and the algorithm ends until the next image capture as denoted by block 84.

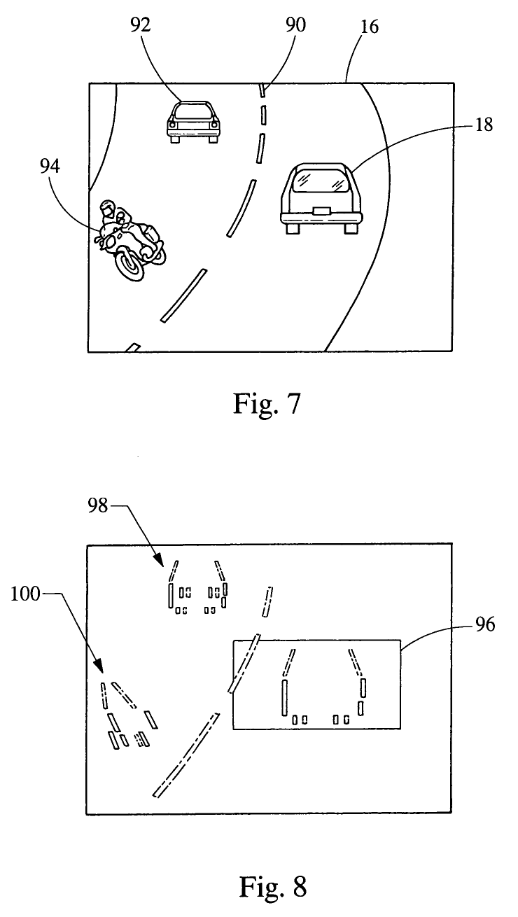

Now referring to FIG. 7, a typical electronic image as seen by the camera 12 is provided and will be used to further describe the method implemented by the processor 14 to determine the range and lateral position of the vehicle 18. The electronic image includes additional features that could be confusing for the processor 14 such as the lane markings 90, an additional car 92, and a motorcycle 94.

FIG. 8 shows a vertically edge enhanced image. The electronic image is comprised of horizontal rows and vertical columns of picture elements (pixels). Each pixel contains a value corresponding to the brightness of the image at that row and column location. A typical edge enhancement algorithm includes calculating the derivative of the brightness across the horizontal rows or vertical columns of the image. However, many other edge enhancement techniques are contemplated and may be readily used. In addition, the position and size of the window 96 is calculated for a given target range. Edge information located outside the window 96 is ignored. In this instance, much of the edge enhanced information from the car 98 and the motorcycle 100 can be eliminated.

Now referring to FIG. 9, the edge enhanced image is then trinarized, meaning each of the pixels are set to a value of −1, +1, or 0. A typical method for trinarizing the image includes taking the value of each pixel value and applying an upper and lower threshold value, where if the brightness of the pixel value is above the upper threshold value, the pixel value is set to 1. If the brightness of the pixel value is below the lower threshold value, the pixel value is set to −1. Otherwise, the pixel value is set to 0. This effectively separates the pixels into edge pixels with a bright to dark (negative) transition, edge pixels with a dark to bright (positive) transition, and non-edge pixels. Although, the above described method is fast and simple, other more complicated thresholding methods may be used including local area thresholding or other commonly used approaches. Next, the pixels are grouped based on their relative position to other pixels having the same value. Grouping of these pixels is called segmentation and each of the groups is referred to as a line-segment. Height, width and position information is stored for each line- segment.

Relating these segments back to the original image, Segment 102 represents the lane marking on the road. Segment 104 represents the upper portion of the left side of the vehicle. Segment 106 represents the lower left side of the vehicle. Segment 108 represents the left tire of the vehicle. Segment 1 10 represents the upper right side of the vehicle. Segment 112 represents the lower right side of the vehicle while segment 114 represents the right tire.

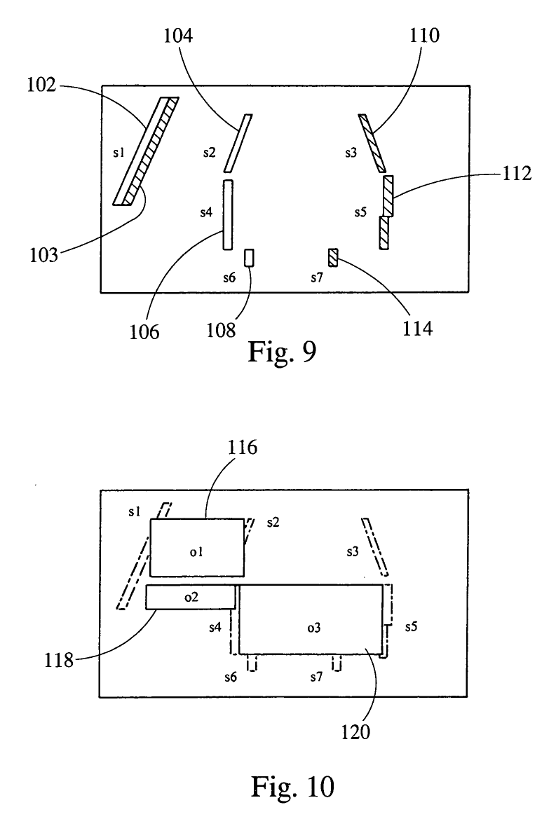

Now referring to FIG. 10, objects may be constructed from two segments. Typically, a positive segment would be paired with a negative segment. Segment 103 and segment 104 are combined to construct object 116. Segment 103 and segment 106 are combined to construct object 118. In segment 106 and segment 112 are combined to construct object 120.

The characteristics of each object will then be evaluated by the characteristics of a model vehicle. A model is selected for each object based on the width of the object. For example, if the object width is smaller than a first width threshold a model corresponding to a motorcycle will be used to evaluate the object. If the object width is larger than the first width threshold but smaller than a second width threshold, a model corresponding to a Sedan is used. Alternatively, if the object width is greater than the second width threshold, the object is evaluated by a model corresponding to a large truck. While only three models are discussed here, a greater or smaller number of models may be used.

Each model will have different characteristics from the other models corresponding to the characteristics of a different type of vehicle. For instance, the vertical-lateral ratio in the Motorcycle model is high, but the vertical-lateral ratio in the Sedan model is low. These characteristics correspond to the actual vehicle, as the motorcycle has a small width and large height, but the sedan is opposite. The height of the object is quite large in Truck model but small in the Sedan model. The three models allow the algorithm to accurately assign a score to each of the objects.

The characteristics of the objects are compared with the characteristics the model. The closer the object characteristics meet the model characteristics the higher the score will be, and the more likely the object is a vehicle of the selected model type. Certain characteristics may be weighted or considered more important than other characteristics for determining if the object is a vehicle. Using three models enables more precise judgment than a single model, because the three types of vehicles are quite different in the size, height, shape and other criteria necessary for identifying the vehicle. These three models also contribute to an improvement in the range accuracy of the algorithm.

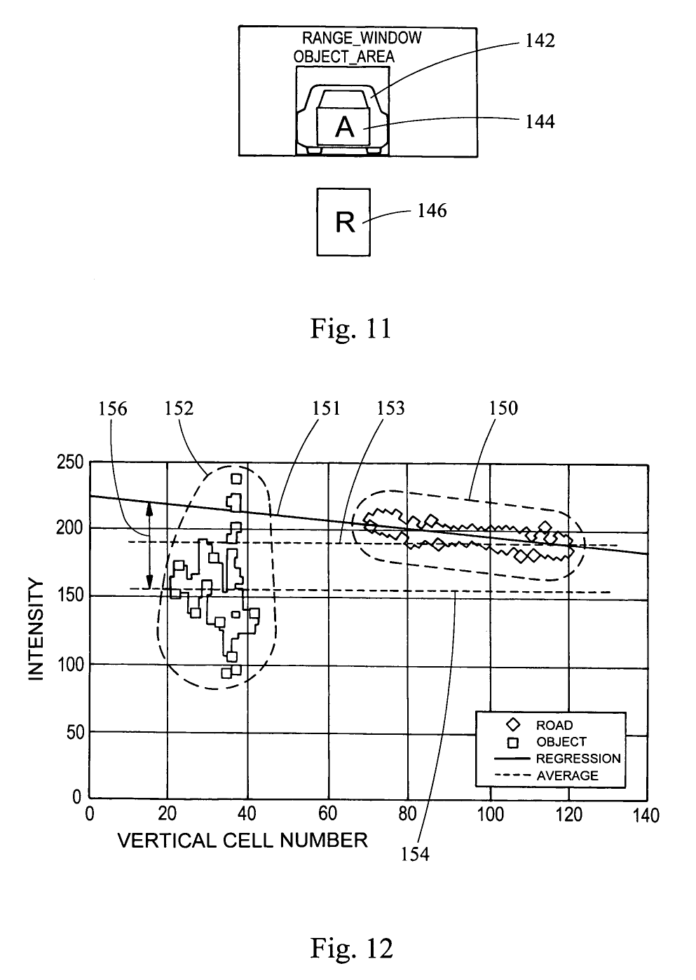

To complement the range-window analysis, the road surface analysis is also performed. The original grey scale captured image is also used to improve the judgment whether an object is a vehicle or not. As shown in FIG. 11, a vehicle 142 is located in front of the system. The grey scale or brightness value of a background element, such as the road, generally changes in a gradual fashion. Therefore, the change in brightness or pixel value for the road can be described by a smooth continuous equation. Often the equation may be a simple linear equation, however other mathematical relationships, such as quadratic equations, or lookup tables also are contemplated herein. Accordingly, a road region 146 is used to determine the gradient or change in brightness of the road in front of the system. The road region 146 is located in the image between the system and an object region 144 in an area that would typically be empty space between the system and the preceding vehicle 142. The value of the pixels within the road region 146 can be used to calculate an equation that corresponds to the expected pixel values of the road at various locations in the image. In addition, the object region 144 may be located at the position of the object. The value of the pixels inside of the object region 144 may be compared to the expected pixel value of the road and a determination can be made or a score calculated indicating whether the vehicle exists in the object region 144.

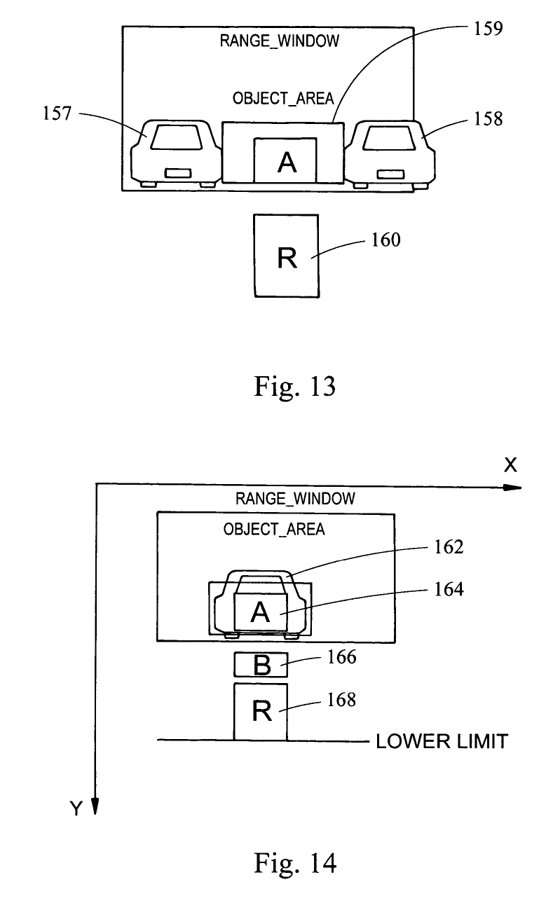

This process can be further explained relative to the chart in FIG. 12. A group of pixel values 150 are presented and correspond to the pixels contained within the road region 146. The group of pixel values 150 may be used in a regression algorithm, such as a linear regression, to determine an equation 151 for the expected pixel values in the object region 144 for the road including the change in road brightness across the image. The second group of pixel values 152 represent the pixel values of the object region 144 corresponding to the location of the object. The average value of the first group of pixels 150 is denoted by line 153 and the average value of the second group of pixels 152 is denoted by line 154. The difference between the average value 153 and the average value 154 is only about 40 grey levels. The difference is not large enough in comparison with intensity variation of 150. However, the difference 156 between the average value of the second group of pixels 152 and the expected pixel value based on the equation 151 at the corresponding pixel position (approximately 30 along the horizontal axis) is approximately 70 grey levels. This difference is much larger than the standard deviation of the regression line. Therefore, the validity of the object identification is improved. This is particularly helpful in the situation illustrated in FIG. 13, where the object may be created based on two vehicles 157 and 158 located in lanes adjacent to the system. In this situation, the pixel values of the region 159, a ghost object created by the right edge of vehicle 157 and the left edge of vehicle 158, would substantially match the expected road pixel values determined from region 160. Accordingly the score of the object would be lowered.

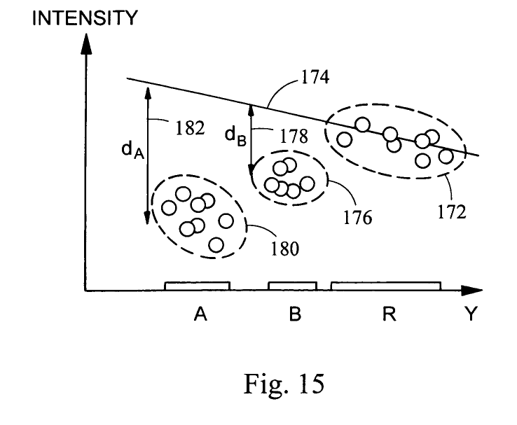

In another embodiment described below, three regions may be used to determine the validity of the object in question as shown in FIGS. 14 and 15. The object 162 is located within the field of view of the system. Region 168 is utilized to calculate an equation describing expected pixel value at various locations on the road due to the gradient of the road brightness. Region 164 is located at the position of the object 162. The deviation of the pixel values in region 164 is compared to the expected pixel values based on the equation. For example, the deviation of the pixel values in region 164 from the expected pixel values is calculated. If the deviation is small, then the object is judged as a ghost object (an object formed by two vehicles in adjacent lanes). Alternatively, if the deviation is high, the likelihood of the object being a vehicle is scored higher. However, if the deviation of the pixel values in region 166 is large, the likelihood of the object being a vehicle will be reduced because the shadow of other vehicles and road-side object might change the intensity in region 164 and 166. If the values in region 168 do not provide a good linear regression (i.e. a linear regression with a small standard deviation), then the values in region 166 are compared to region 164 directly without using the linear regression.

The three region processing illustrated in FIGS. 14 and 15 is described in detail. A region 166 located between region 164 and 168 is also used. A first group of pixel values 172 correspond to the pixel values of region 168. The group of pixel values 172 are used to determine an expected road brightness gradient as denoted by reference numeral 174. The road brightness gradient is determined in FIG. 15 by a linear regression that is performed on the group of pixel values 172. Group 176 corresponds to the pixel values of region 166 and group 180 corresponds to the pixel values of region 164. The deviation 182 of group 180, dA, is calculated from the expected pixel value based on the expected road brightness gradient 174. The deviation 178 of group 176 from the expected road brightness gradient 174, d_{B}, is also calculated.

If d_{A} is smaller than or the same order as the standard deviation of the regression line, the region 164 is judged as “Ghost” object. If d_{A} is much larger than the standard deviation, the region 164 has a high likelihood of being a vehicle and receives high score. However, when the dB is also large, the score is reduced since a shadow might exist across region 166.

At short range, the region 172 does not have enough length along the longitudinal direction (y-axis in Fig.15). In this case, the intensity of the region 180 and 176 is compared. If the average of the intensity is similar, the score is low. If the average is much different, a high score is given.

Each of the objects are then scored based on characteristics of the object, including the width of the object, the height of the object, the position of the object relative to the bottom edge of the window, the segment width, the segment height, and the comparison of the object region pixel values with the expected road pixel values. The above process is repeated for multiple windows with different target ranges.

The object with the best score is compared with a minimum score threshold. If the best score is higher than the minimum score threshold the characteristics of the object are used to determine the object's range and lateral position.

As a person skilled in the art will readily appreciate, the above description is meant as an illustration of implementation of the principles this invention. This description is not intended to limit the scope or application of this invention in that the invention is susceptible to modification, variation and change, without departing from spirit of this invention, as defined in the following claims.

I/We claim:

1. A system for determining range of a vehicle, the system comprising:
a camera configured to view a region of interest including the vehicle and generate an electrical image of the region;
a processor in electrical communication with the camera to receive the electrical image, wherein the processor is configured to construct a plurality of objects indicative of potential vehicle locations, calculate a relationship corresponding to an expected road pixel value, and perform a comparison between object pixel values located proximate the objects and the expected road pixel value.

2. The system according to claim 1, wherein the relationship is an equation calculated based on pixel values of a road region.

3. The system according to claim 2, wherein the equation is a linear equation.

4. The system according to claim 1, wherein the processor calculates the relationship based on a regression algorithm.

5. The system according to claim 1, wherein the processor is configured to calculate a deviation between the object pixel values and the expected road pixel value.

6. The system according to claim 1, wherein the processor is configured to calculate a score for the object based on the comparison.

7. The system according to claim 6, wherein the range of the vehicle being determined based on the score of the object.

8. The system according to claim 6, wherein the processor is configured to identify a plurality of windows within the electrical image, each window of the plurality of windows corresponding to a predetermined physical size at a target range from the camera, the processor being further configured to evaluate characteristics of the electrical image in relation to each window to identify the vehicle.

9. The system according to claim 8, wherein the objects are constructed from edge segments generated based on the enhanced edge image.

10. The system according to claim 9, wherein the edge segments are vertical edge segments.

11. The system according to claim 9, wherein the score is based on a height of the edge segments.

12. The system according to claim 9, wherein the score is based on a width of the edge segments.

13. The system according to claim 6, wherein the score is based on a height of the objects.

14. The system according to claim 6, wherein the score is based on a width of the objects.

15. The system according to claim 1, wherein the processor is configured to generate a trinary image based on the edge enhanced image for the determination of the potential vehicle locations.

16. The system according to claim 15, wherein positive edge elements are identified by applying a predefined upper threshold to the edge enhanced image.

17. The system according to claim 15, wherein negative edge elements are identified by applying a predefined lower threshold to the edge enhanced image.

18. The system according to claim 15, wherein the objects are constructed from at least one positive and at least one negative edge segment generated from the trinary image.
